(19) United States
(12) Patent Application Publication
(10) Pub. No.: US 2008/0012236 A1
(43) Pub. Date: Jan. 17, 2008

(54) PACKING CASE SEAL

(76) Inventor: Declan Reilly, Ipswich (GB)

Correspondence Address: SMITH-HILL AND BEDELL, P.C., 16100 NW CORNELL ROAD, SUITE 220, BEAVERTON, OR, 97006, US

(21) Appl. No.: 11/561,489

(22) Filed: Nov. 20, 2006

(30) Foreign Application Priority Data
Jul. 11, 2006 (GB) 0613708.7

(51) Int. Cl. F16J 15/00

(52) U.S. Cl. 277/318; 702/51

(57) ABSTRACT

An apparatus and method for monitoring the performance of a packing case seal, including a vent 24, 26 leading from the interior of the packing case and a gas meter 32 connectable to the vent 24, 26 to determine any gas flow through the vent 24, 26 over time.

This invention concerns apparatus for monitoring the performance of a packing case seal, particularly but not exclusively a compressor packing case seal, and also a method of monitoring the performance of a seal packing case or seals that fit around a piston rod or similar to provide a dynamic seal.

Packing case seals typically include a number of seals around a piston rod, the seals being located in a case. The seals often comprise a ring through which the piston rod passes, with the ring held in a separate groove or packing cup. Such seals may be provided in compressors to prevent high pressure gas passing back into the crank case. Such compressors can be rotary, reciprocating, centrifugal screw or otherwise.

Over time the effectiveness of these seals decreases due to wear and also debris in the compressor. Conventionally, packing cases have been replaced on a regular maintenance schedule. This can mean that seals are replaced which are performing satisfactorily. Furthermore, cases which are leaking significantly may not be detected, and may not therefore be replaced or repaired for some time. This could result in a significant waste of gas resulting in both adverse economic and environmental impact (green house effect) and could also produce hazardous conditions.

According to the present invention there is provided apparatus for monitoring the performance of a packing case seal, the apparatus including a vent leading externally from the interior of the packing case, and a gas meter locatable to measure gas passing through the vent to indicate the amount of leakage of the packing case seals.

The gas meter may use thermal dispersion technology.

The gas meter may include connection means to permit selective connection to the vent to periodically measure gas passing therethrough. The gas meter may be portable.

The gas meter may include remote connection means to permit the meter to be remotely readable. The remote connection means may be configured to permit reading by infra red, radiowave or electronic cable communication.

The gas meter may include alarm means configured to provide an alarm signal when a gas flow above a predetermined level is measured.

A pressure sensing device may be provided configured to measure the pressure drop across the gas meter. The pressure sensing device may be incorporated in the gas meter.

The pressure sensing device may be configured to provide an alarm signal when a pressure drop above a predetermined level is measured.

The pressure sensing device may be an integrated differential pressure sensing device.

The packing case seal may be a compressor packing case seal.

The invention also provides a method of monitoring the performance of a packing case seal, the method comprising measuring gas leakage from the seal using apparatus according to any of the preceding nine paragraphs.

The amount of leakage over time may be measured and recorded to monitor degradation of the seal.

When a pressure drop across the gas meter above a predetermined level is measured, the gas meter may be cleaned or replaced.

Embodiments of the present invention will now be described by way of example only and with reference to the accompanying drawings, in which:

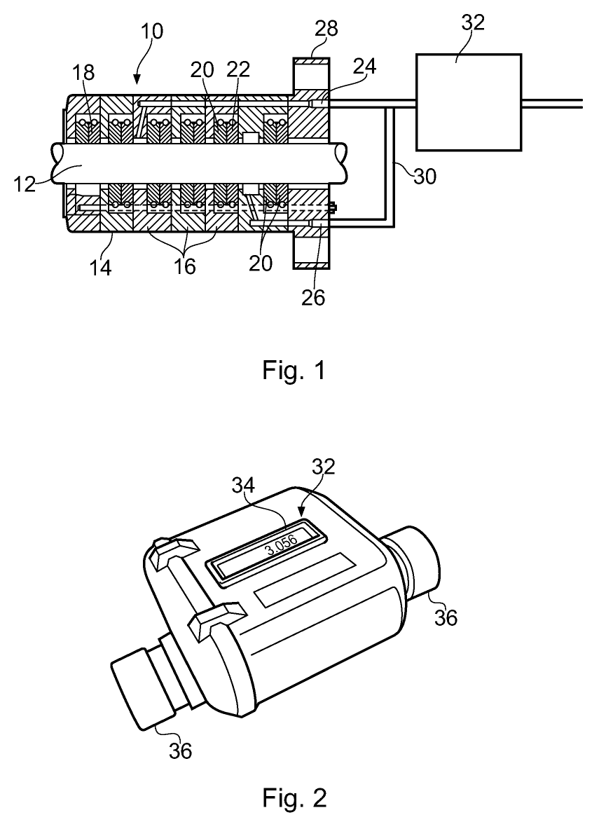

FIG. 1 is a diagrammatic cross sectional view through a packing case seal and apparatus according to the invention;

FIG. 2 is a diagrammatic perspective view of a part of the apparatus of FIG. 1;

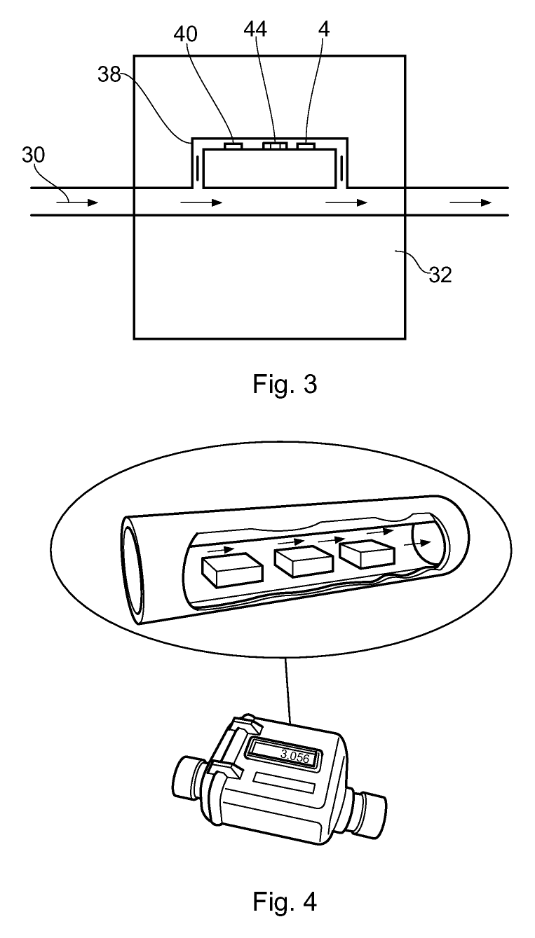

FIG. 3 is a diagrammatic view illustrating the operation of the apparatus of FIG. 2;

FIG. 4 is a diagrammatic perspective view with a detailed highlight of the apparatus of FIG. 2;

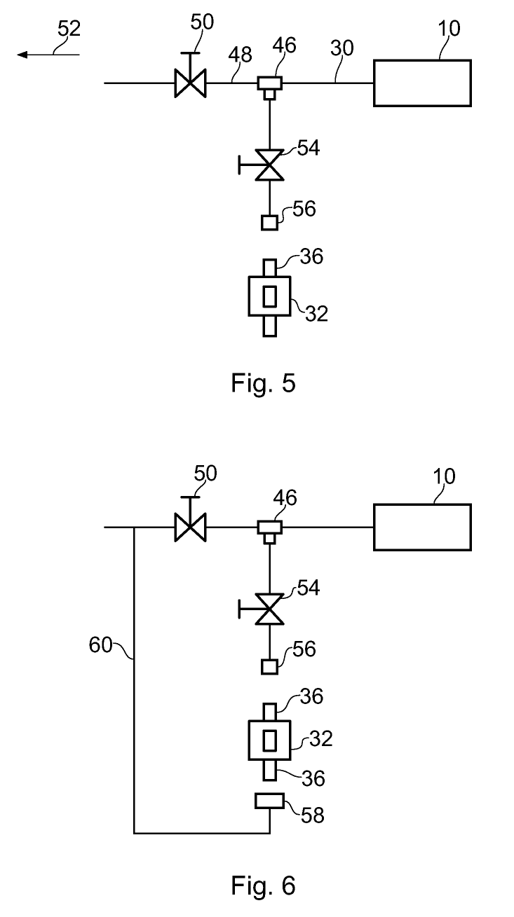

FIG. 5 is a block diagram illustrating how apparatus and a method according to the invention can be operated; and

FIG. 6 is a similar view to FIG. 5 of an alternative arrangement.

FIG. 1 of the drawings shows a packing case seal 10 for sealing around a piston rod 12 of a gas engine driven compressor, the remainder of which is not visible. The seal 10 includes a casing 14 in which are located six seal rings held in packing cups 16. The left most seal as shown in the drawing comprises a PTFE ring 18. The next four ring seals moving to the right all include a PTFE ring 20, supported on the right hand side as shown by an annular metal ring 22. The right most seal comprises two PTFE rings 20.

Materials used for packing seals generally fall into two categories; metallic (typically bronze or cast iron) and non metallic (typically carbon graphite, PTFE or other suitable plastics).

Two vents 24, 26 extend from the interior of the casing 14, with the first vent 24 extending from adjacent to the left hand end of the casing, and the second vent 26 extending from towards the right hand end. The vents pass through a flange 28 at the right hand end of the casing 14, and connect via pipes 30 to a thermal dispersion flow meter 32.

The flow meter 32 can be used in two modes. The first is with the meter 32 permanently connected to the pipes 30. The second mode is where the meter 32 is only connected to the pipes 30 periodically to provide measurements at required times.

FIG. 2 shows a typical thermal dispersion flow meter 32 with an LCD display 34 and two quick connection couplings 36. The meter 32 can be mains powered or battery operated. The meter 32 can be read using the screen 34 and/or can provide remote reading. To enable remote reading a range of electronic interfaces can be incorporated which may operate via infra red, radiowave (Bluetooth) or electronic cable (RS232 RS485 Can Bus etc).

In use, the amount of gas escaping from around the piston rod 12 into the interior of the casing 14 is measured by the meter 32, and this measurement is monitored over time to check for any degradation of the seal 10. With a knowledge of the amount of gas leaking from the seal 10, a decision can be made as to when it is economically appropriate to renew or repair the seal 10 comparing the cost of the work and downtime, relative to the amount of gas being wasted.

The meter 32 may be configured to allow alarm outputs or warning levels to be set. These can be adjusted dependent on the field of the application. The alarms or warnings could be audible and/or visual. Alternatively or in addition, an output could be sent to a central control point such as for instance a compressor control room.

The alarms/warnings could be used to indicate that a packing case has reached the economic threshold point whereby it is cost effective to replace the packing case. The alarms/warnings could be used to indicate that emissions have reached a critical point, e.g. limitations as set by environmental legislation. Where gases pose a threat to health, the alarms/warnings could be used to indicate that gas levels have exceeded the safety limits.

The alarms/warnings could be used automatically to relay a message to the suppliers of the packing cases and/or any relevant party whose responsibility it is to ensure that there is sufficient stock availability of packing cases to cover any impending replacements. The meter is thus used to economically monitor and control stock levels of packing cases.

A thermal dispersion flow meter has been found to be very advantageous in applications such as compressor seal monitoring with relatively harsh working conditions, but which conditions do not significantly affect such a flow meter as it has no working parts. Such meters have a very high dynamic range, i.e. they are good at measuring relatively low flow rates as well as high flow rates, which can both be encountered in such applications.

Since a thermal dispersion meter is a solid state device, with no moving parts, it is immune to the vibration effects encountered with normal compressor running. In addition, having no moving parts makes the meter dirt tolerant, which can be critical in the case of contaminated or dirty gas. Another advantage of a thermal dispersion meter is the ease of installation into the packing vent pipe. The meter can be installed in any orientation and does not require any flow conditioning (i.e. does not require an upstream and downstream length of undisturbed flow). A thermal dispersion meter is also able to automatically compensate for variations in vent gas pressure and temperature (i.e. the accuracy of the meter is unaffected by variations in gas vent pressure or temperature).

There are several variants of thermal dispersion techniques used for flow measurements. The technique and principal of operation probably most suited to monitoring packing case seals is shown in FIGS. 3 and 4. Flow from the packing case vent pipe 30, passes through the thermal dispersion meter 32. A small proportion of the total flow is split off into a bypass 38. A bypass configuration makes use of the temperature difference between two sensors 40 and 42 located symmetrically upstream and downstream of a heater 44.

When there is no gas flow, the heat effected zone (HAZ) is symmetrically displaced around the heater and T1−T2=0. As flow begins through the meter, the temperature T1 begins to fall due to the forced convection effect, and the temperature T2 begins to rise as the heater imparts a specific and constant amount of heat into the gas stream. The resulting temperature difference between T1 & T2 is indicative of the mass flow rate of gas.

As indicated the meter may have a remote reading capability which allows the meter to be used in remote or difficult to access areas, prohibited or restricted areas and hazardous area. A typical application for such a device is monitoring packing cases on large industrial reciprocating compressors, used in oil and gas production, processing and transportation. These applications are typically defined as hazardous areas.

As indicated the meter 32 can be used for continual inline monitoring and also as a portable handheld device for periodic monitoring. The couplings 36 permit ready connection and disconnection of the meter 32 to permit periodic monitoring.

FIG. 5 illustrates an arrangement usable for periodic monitoring. Here the seal 10 connects via the pipe 30 to a T-piece 46. A connection 48 extends to an on/off valve 50. When monitoring is not taking place the valve 50 will be open and gasses will vent as shown by the arrow 52. The branch from the T-piece 46 leads to a further on/off valve 54 which connects to a quick connect coupling 56. For monitoring purposes the coupling 56 can be connected to a one of the couplings 36 on the meter 32. During monitoring the valve 50 will be closed and the valve 54 open such that gasses venting through the pipe 30 will pass through the meter 32 prior to venting to atmosphere, and thus the gas flow can be measured.

FIG. 6 shows a similar arrangement but in this instance the output coupling 36 of the meter 32 connects via a coupling 58 to a bypass 60 such that the gas exhausts in the same way whether or not monitoring is taking place.

In the case of a portable meter, the meter may have memory storage capability allowing readings from various packing cases to be stored, compared, tabulated as required. The meter may have a communication port such as a USB port to allow data stored therein to be downloaded to a suitable electronic device such as a computer.

There is thus provided apparatus for and a method of monitoring gas loss in a packing case seal to provide for an improved and more cost effective maintenance or replacement programme. The apparatus is of relatively straightforward configuration providing for long term reliable essentially maintenance free operation.

In a further embodiment of the invention, an integrated differential pressure sensing device to measure the pressure drop across the meter is included. In some applications, the gas being measured can be contaminated. Contamination may be in the form of oil contamination (oil vapour) from various parts of the compressor. Other forms of contamination may include foreign particles from old/worn gas piping. The type of gas being used may have contaminants inherent in its composition, such as gas with a high salt concentration. Contaminants in the gas stream could cause the meter to gradually foul over time, thus restricting the gas flow and having an adverse effect on the accuracy of the meter. An integrated differential pressure sensor, measuring the pressure drop across the meter, would provide a direct measurement of the amount of fouling within the gas meter.

The differential pressure sensor would be incorporated into the meter and would provide a visual (e.g. LCD or LED output) or audible indication that the fouling of the meter has reached a critical point whereby the accuracy of the meter is not within the required specification. The differential pressure sensor defines the point at which the meter needs to be cleaned and/or replaced. The differential pressure sensor helps maintain the accuracy of the instrument over time when used in contaminated gas applications.

It is to be realised that various other modifications may be made without departing from the scope of the invention. For example the invention could be used with different seals, including, but not restricted to scrubbers, relief valves, traps, valve packing and vacuum applications. The invention could be used for conditioning monitoring of seals on any type of reciprocating or rotating machinery. Different meter types could be used.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. Apparatus for monitoring the performance of a packing case seal, the apparatus including a vent leading externally from the interior of the packing case, and a gas meter locatable to measure gas passing through the vent to indicate the amount of leakage of the packing case seals.

2. Apparatus according to claim 1, wherein the gas meter uses thermal dispersion technology.

3. Apparatus according to claim 1, wherein the gas meter includes connection means to permit selective connection to the vent to periodically measure gas passing therethrough.

4. Apparatus according to claim 3, wherein the gas meter is portable.

5. Apparatus according to claim 1, wherein the gas meter includes remote connection means to permit the meter to be remotely readable.

6. Apparatus according to claim 5, wherein the remote connection means is configured to permit reading by infra red, radiowave or electronic cable communication.

7. Apparatus according to claim 1, wherein the gas meter includes alarm means be configured to provide an alarm signal when a gas flow above a predetermined level is measured.

8. Apparatus according to claim 1, wherein a pressure sensing device is provided configured to measure the pressure drop across the gas meter.

9. Apparatus according to claim 8, wherein the pressure sensing device is incorporated in the gas meter.

10. Apparatus according to claim 8, wherein the pressure sensing device is configured to provide an alarm signal when a pressure drop above a predetermined level is measured.

11. Apparatus according to claim 8, wherein the pressure sensing device is an integrated differential pressure sensing device.

12. Apparatus according to claim 1, wherein the packing case seal is a compressor packing case seal.

13. A method of monitoring the performance of a packing case seal, the method comprising measuring gas leakage from the seal using apparatus including a vent leading externally from the interior of the packing case, and a gas meter locatable to measure gas passing through the vent to indicate the amount of leakage of the packing case seals.

14. A method according to claim 13, wherein the amount of leakage over time is measured and recorded to monitor degradation of the seal.

15. A method according to claim 13, wherein any pressure drop across the gas meter is measured, and when a pressure drop across the gas meter above a predetermined level is measured, the gas meter is cleaned or replaced.
